(19) United States
(12) Patent Application Publication
(10) Pub. No.: US 2008/0270132 A1
(43) Pub. Date: Oct. 30, 2008

(54) METHOD AND SYSTEM TO IMPROVE SPEAKER VERIFICATION ACCURACY BY DETECTING REPEAT IMPOSTERS

(76) Inventors: Jari Navratil, White Plains, NY (US); Ganesh N. Ramaswamy, Mohegan Lake, NY (US); Ran D. Zilca, Briarcliff Manor, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/132,013

(22) Filed: Jun. 3, 2008

Related U.S. Application Data
(63) Continuation of application No. 11/199,652, filed on Aug. 9, 2005.

(51) Int. Cl. G10L 17/00

(52) U.S. Cl. 704/250; 704/E17.001

(57) ABSTRACT

A system and method for identifying an individual includes collecting biometric information for an individual attempting to gain access to a system. The biometric information for the individual is scored against pre-trained imposter models. If a score is greater than a threshold, the individual as an imposter is identified as an imposter. Other systems and methods are also disclosed.

### RELATED APPLICATION INFORMATION

This application is a Continuation application of co-pending U.S. patent application Ser. No. 11/199,652 filed on Aug. 9, 2005, incorporated herein by reference in its entirety.

### BACKGROUND

1. Technical Field

The present invention relates to user authentication and identification systems and methods for determining the identity of a user, and more specifically, to the ability to recognize the identity of a speaker given a sample of his/her voice.

2. Description of the Related Art

Speaker verification systems determine whether or not an identity claim made by a user is correct. Such systems make this decision by comparing an input utterance coming from a user to a target speaker model that has been previously generated from analyzing the speaker's voice. A speaker verification system either accepts the user or rejects her typically by generating a biometric similarity score between the incoming utterance and the target speaker model, and applying a threshold such that scores above the threshold result in acceptance and lower scores result in rejection.

Current speaker verification systems use pre-trained imposter models based on a set of held-out speakers that are not expected to participate during the operational life cycle of the system. The use of imposter models improves speaker verification accuracy by allowing the system to model not only the voice of the target user, but also the way the speaker sounds compared to other speakers.

### SUMMARY

Current approaches do not take into consideration that in practice, fraudulent users may try to break into a user's account multiple times, allowing the system to learn the characteristics of their voices by creating a speaker model, so that when they try to access the system again they may be identified. The present invention solves this problem. In one embodiment, this problem is solved by training speaker models from rejected test utterances, or from utterances that have been externally identified as fraudulent, and by using biometric similarity scores between newly generated models and future incoming speech as an indication for a repeat imposter. The accuracy of the resulting speaker verification system is enhanced since the system can now reject an utterance both on the grounds that the target speaker score is low, or on the grounds that one of the repeating imposters is detected.

A system and method for identifying an individual includes collecting biometric information for an individual attempting to gain access to a system. The biometric information for the individual is scored against pre-trained imposter models. If a score is greater than a threshold, the individual as an imposter is identified as an imposter.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for verifying an identity of an individual in accordance with an illustrative embodiment of the present invention; and

FIG. 2 is a block/flow diagram showing another system/method for verifying an identity of an individual in accordance with another illustrative embodiment of the present invention.

### DETAILED DESCRIPTION OF PREFERRED EMBODIMENTS

Aspects of the present invention include improved system security for voice or semantic verification systems. During the operational life cycle of a speaker verification system, new imposter speaker models are created to prevent authorization of repeat imposters. These new models provide future indication of a repeat break-in attempt from the same speaker or individual.

New imposter models may be created on utterances that the speaker verification system chose to reject (e.g., utterances that generated very low speaker verification scores), and/or on utterances that were detected to be break-in attempts by an external system (e.g. forensic investigation or offline fraud detection system).

Once new imposter models are available, a speaker verification system may be designed to detect the repeat imposter explicitly or implicitly. For example, the system may apply a standard speaker verification algorithm to score incoming speech against the new imposter models and decide that a call is fraudulent if the score with respect to any new imposter model is high. In one case, the repeat imposters are detected explicitly. A contrast example where repeat imposters are detected implicitly is when the new imposter models are simply used together with existing pre-trained imposter speaker models, and used in the same manner. In this case, the imposter speaker will be employed as a cohort or t-norm speaker.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

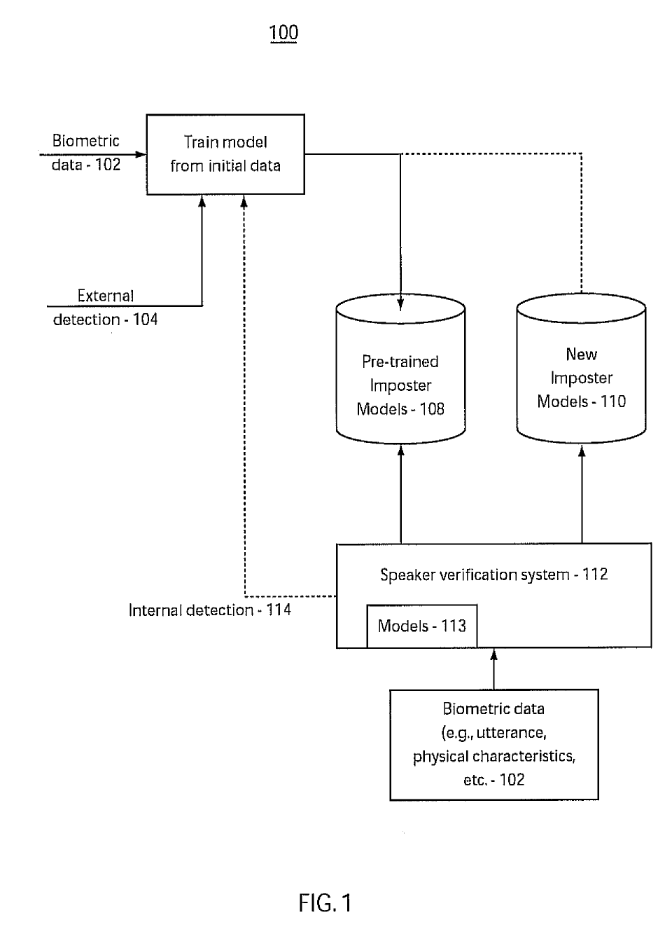

Referring now to the drawings in which like numerals represent the same or similar elements and initially to FIG. 1, a block/flow diagram showing an illustrative embodiment of the present invention is shown. A security system 100 includes the ability to receive authorization attempts, permit access to an authorized user or users based on biometric information collected by the system in real-time, prevent access to unauthorized users or imposters and train models to improve rejection of repeat imposters or unauthorized users. System/method 100 may be employed in conjunction with other systems or as a stand alone system. System 100 may be employed with security systems which permit or prevent access for offices, homes, vehicles, computer systems, telephone systems, or any other system object where security is an issue.

While the present invention will be described in terms of speaker recognition, the present invention includes employing any form of biometric information for determining an impostor or unauthorized user and training models for this determination. Biometric information may include speech, gestures, fingerprints, eye scan information, physiological data, such as hand size, head size, eye spacing/location, etc. or any other information which can identify an individual or group of individuals.

A speaker verification system 112 uses a pre-trained set of imposter speaker models 108 augmented by an additional set of new imposter models 110. models may take many forms and may include, e.g., Hidden Markov Models (HMMs), Gaussian Mixture Models (GMMs), Support Vector Machines (SVMs) or other probability models. A decision 114 to create an imposter speaker model 110 from a test utterance 102 may be based on external information 104 (e.g. a following fraud complaint by a genuine user) or internal information (e.g. very low similarity score for the trial). It may also be based on a combination of the two or an alternate method. Block 106 may be designed to train a model to prevent authorization of a speaker or speakers from gaining access to the system. The model training may be triggered in accordance with a threshold comparison (e.g., low similarity score to existing user profiles or models) or other input (102, 104) or a combination of events and inputs.

When used in a framework of Conversational Biometrics (see e.g., U.S. Pat. No. 6,529,871, incorporated herein by reference) where user verification is performed based both on the knowledge match and speaker verification match, the indication for training new imposter models may be a poor knowledge score of the user.

Once the decision to create a new imposter model 110 is made, an imposter speaker model is trained from the test utterance 102. Current implementations of speaker verification algorithms allow such training of new speaker models to be done at a very low computational cost, since the statistics gathered for the purpose of scoring may be reused for creating a speaker model. Next, when the same speaker needs to be verified, the similarity score between the new imposter model and the new test utterance is measured. If the score is high, it indicates a high probability that the same imposter is attempting break-in. The indication of a repeat imposter may be explicit, by examining the score, or implicit, by adding the score to a pool of other imposter scores (e.g. cohort speakers, t-norm). See e.g., R. Auckenthaler, M. Carey, and H. Lloyd-Thomas, “Score Normalization for Text-Independent Speaker Verification Systems,” Digital Signal Processing, Vol. 10, No. 1, pp. 42-54, 2000.

In one illustrative example, a non-authorized user attempts to access a computer system by uttering a secure codeword or identifying their name, etc. The system reviews the utterance to provide a similarity score against user models stored in the system. Test utterances may be detected as fraudulent by the speaker verification system itself, for example by detecting a very low biometric similarity score on a claimant target model.

Since the non-authorized user does not have a model or an imposter's utterance would not be similar to the person the imposter is claiming to be, a low similarity score may be returned, and the non-authorized user is denied access to the system. The fact that the imposter's utterance is not modeled with a direct imposter model does not mean that the score will be lower. The score may be thought of as a ratio, lower since both the input does not match that target model and because the input matches the imposter model. Depending on the systems settings, a model is trained using the user's utterance if a model exists which correlates to the present imposter. If the non-authorized user returns and attempts access again, the system compares features of the new utterance with the newly trained imposter model. If a high probability exists that the user is an imposter, the imposter is denied access to the system. Other information, such as biometric information, a photograph or other information may be collected and recorded to identify the imposter or sent to the proper authorities for investigation.

In one embodiment, an individual speaks a test utterance to the verification system 112. The test utterance may be a prompted statement or statements that the individual is asked to state, e.g., “state your name and the phrase ‘access my account’”. The utterance is then compared to all models 113 including imposter models 108 within the system 100.

The system 100 may include only imposter models 108 and is used to only deny access to these individuals. If a match is made with the imposter models 108, the individual is identified as an imposter or unauthorized user and denied access. In other embodiments, the system 100 may include authorized users, each having their own model or models 113 stored in the system 100 or 112. If a match is made with the models 113, the individual is identified as an authorized user. If a match is made with one of the imposter models 108, the individual is identified as an imposter or unauthorized user. If no match exists with models 113 or models 108, then the system 100 trains a new imposter model 110. Training may include known methods for training models, The new imposter models 110 will be employed in future access attempts.

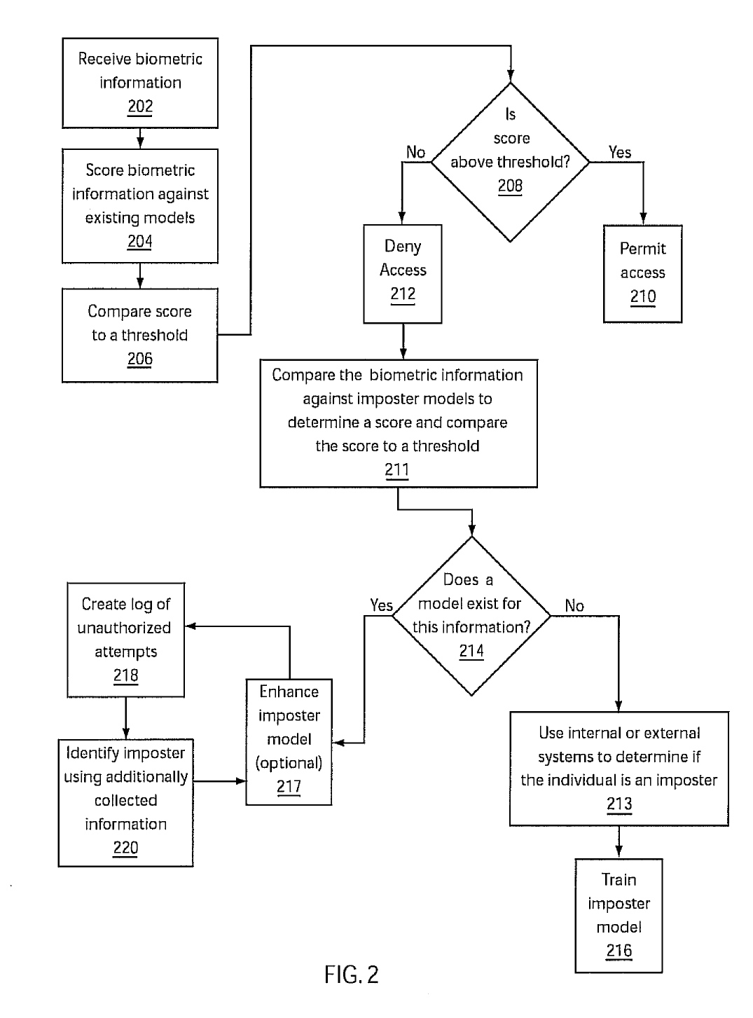

Referring to FIG. 2, a method and system to enhance speaker verification accuracy by creating imposter models from test utterances or the like that are suspected to be fraudulent is illustratively shown in accordance with one embodiment. In block 202, a system or subsystem receives biometric information (e.g., a test utterance) from an individual attempting to gain access to sensitive material, log into a system, or otherwise gain access to a secure location or information. The biometric information may include speech patterns, fingerprints, retina scan information or any other biometric information which indicates the unique identity of an individual.

In block 204, the biometric information is compared to models existing in storage to compute a score (e.g., a similarity score) based on the probability that the individual is approved to access the system. Many algorithms exist for computing a score for based on biometric information, e.g., creating feature vectors and comparing the feature vectors to models (e.g., HMMs).

Once the score is determined, the score is compared to a threshold in block 206. The threshold may be set depending on the level of security needed.

In block 208, if the score is greater than the threshold, access may be permitted for the individual in block 210. Otherwise, if the threshold is not met, access is denied to the individual in block 212.

If the biometric information is rejected as an unauthorized user, the system compares the biometric information against imposter models in block 211. The decision to identify the individual as an imposter may be based upon a similarity score between the biometric information and any imposter model meeting a threshold. Alternately, a function of the similarity scores between the biometric information and all or a subset of the imposter models meeting a threshold may be performed. For example, the function may include an average, a weighted average or any other function. In another embodiment, all similarity scores may be passed and evaluated between the biometric information and all or a subset of the imposter model(s) to decide on user rejection based on all the computed similarity scores.

In block 213, if the similarity scores do not exceed the threshold, a decision may be made as to whether the individual is fraudulent based on other information. For example, an imposter trying to gain access to the system by pretending to be an authorized user may be determined by employing an external system, such as a customer fraud complaint, offline fraud detection system, or forensic investigation. In this way, an imposter alert or warning may be introduced to identify an imposter or that an imposter may be attempting to access a given individual account, etc. This information may be considered in a pre-trained imposter model (see e.g., block 214) or be checked separately to identify an imposter.

A determination is made in block 214 as to whether an imposter model exists for this individual. If the similarity score is close enough to an existing imposter model then an imposter model exists for this imposter. If an imposter model exists, then the imposter model may be enhanced in block 317 with additional information that has been collected during the present attempt to access the system.

In one embodiment, a log or record may be created for each attempt made by the imposter in block 218. Other information may also be recorded, such as time of day and date, a photo of the imposter, additional speech characteristics, etc. In one embodiment, the log may include additional biometric information about the imposter, such as a photo, fingerprint, retina scan, or other information which would be useful in determining the imposter's identity. Depending on the severity of the scenario, the collected information may be sent to the proper authorities to permit the identification of the imposter in block 220. In addition or alternately, in block 217, the imposter model may be enhanced using additional information provided by the second or additional utterance or attempt to access the system. The new imposter models may be employed in conjunction with existing internal imposter models.

If a model does not exist for the individual, a model is trained using the utterance so that future access attempts may be screened using the newly created imposter model in block 216.

Having described preferred embodiments of a method and system to improve speaker verification accuracy by detecting repeat imposters (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for identifying an individual, comprising the steps of:
collecting biometric information for an individual attempting to gain access to a system;
scoring the biometric information for the individual against pre-trained imposter models; and
if a score is greater than a threshold, identifying the individual as an imposter.

2. The method as recited in claim 1, wherein the step of scoring includes comparing the biometric information to each of the pre-trained imposter models to obtain a similarity score, and comparing each similarity score to the threshold.

3. The method as recited in claim 1, further comprising the steps of:
determining if an imposter model exists; and
if no imposter model exists, training an imposter model based upon the biometric information.

4. The method as recited in claim 1, further comprising the steps of:
enhancing a pre-trained imposter model with the biometric information.

5. The method as recited in claim 1, further comprising the step of recording information about access attempts by the imposter.

6. The method as recited in claim 1, further comprising the step of collecting additional information about the imposter to determine an identity of the imposter.

7. The method as recited in claim 1, further comprising the step of determining whether an individual is an imposter based upon information from an external system.

8. The method as recited in claim 7, wherein the external system is triggered by a customer notification.

9. The method as recited in claim 1, wherein the biometric information includes a test utterance.

10. The method as recited in claim 1, wherein the biometric information includes at least one of a physical feature and/or gesture.

11. A computer program product comprising a computer useable medium having a computer readable program, wherein the computer readable program when executed on a computer causes the computer to perform the steps in accordance with claim 1.

12. A method for verifying an identity of an individual, comprising the steps of:
collecting biometric information for an individual attempting to gain access to a system;
scoring the biometric information for the individual against models for individuals;
if a score is less than a threshold, denying access to the system for the individual;
determining if an imposter model exists for the individual; and
if an imposter model does not exist for that individual training an imposter model.

13. The method as recited in claim 12, wherein the step of determining if an imposter model exists includes comparing the biometric information to each of a plurality of pre-trained imposter models to obtain a similarity score, and comparing each similarity score to a threshold.

14. The method as recited in claim 12, further comprising the steps of:
enhancing a pre-trained imposter model with the biometric information.

15. The method as recited in claim 12, further comprising the step of recording information about access attempts by the imposter.

16. The method as recited in claim 12, further comprising the step of collecting additional information about the imposter to determine an identity of the imposter.

17. The method as recited in claim 12, further comprising the step of determining whether an individual is an imposter based upon information from an external system.

18. The method as recited in claim 17, wherein the external system is triggered by a customer notification.

19. The method as recited in claim 12, wherein the biometric information includes a test utterance.

20. The method as recited in claim 12, wherein the biometric information includes at least one of a physical feature and/or gesture.

21. A computer program product comprising a computer useable medium having a computer readable program, wherein the computer readable program when executed on a computer causes the computer to perform the steps in accordance with claim 12.

22. A method for verifying an identity of an individual, comprising the steps of:
receiving a test utterance from an individual attempting to gain access to a system;
computing a first score for the individual against a model that the individual claims to be;
based on the first score, comparing the test utterance to pre-trained imposter models to determine a second score to determine whether the individual is an imposter; and
if the second score is above a threshold, identifying the individual as an imposter.

23. The method as recited in claim 22, wherein the step of comparing the test utterance to pre-trained imposter models includes comparing the test utterance to each of the pre-trained imposter models to obtain a similarity score, and comparing each similarity score to a threshold.

24. The method as recited in claim 22, further comprising the steps of:
determining if an imposter model exists; and
if no imposter model exists, training an imposter model based upon the biometric information.

25. The method as recited in claim 22, further comprising the steps of:
enhancing a pre-trained imposter model with the test utterance.

26. The method as recited in claim 22, further comprising the step of recording information about access attempts by the imposter.

27. The method as recited in claim 22, further comprising the step of collecting additional information about the imposter to determine an identity of the imposter.

28. The method as recited in claim 22, further comprising the step of determining whether an individual is an imposter based upon information from an external system.

29. The method as recited in claim 28, wherein the external system is triggered by a customer notification.

30. A computer program product comprising a computer useable medium having a computer readable program, wherein the computer readable program when executed on a computer causes the computer to perform the steps in accordance with claim 22.

31. A system for verifying an identity of an individual, comprising:
a verification system interfacing with an individual to determine the individuals identity by collecting biometric data for that individual and to limit access to a secure system or object; and
pre-trained imposter models which store information related to imposters that may or have attempted access to the secure system or object to determine whether the individual is an imposter.

32. The system as recited in claim 31, further comprising a training module which receives that biometric data to create a new imposter model if the individual is determined to be an imposter but no imposter model yet exists for the individual.

33. The system as recited in claim 31, wherein the biometric information includes an utterance.

34. The system as recited in claim 31, wherein the biometric information includes at least one of a physical characteristic of the individual or a gesture.

35. The system as recited in claim 31, further comprising an external detection source which notifies the system of imposters.

36. The system as recited in claim 35, wherein the external detection source includes one of a customer fraud complaint, an offline fraud detection system, or a forensic investigation result.
